(19) United States
(12) Patent Application Publication
(10) Pub. No.: US 2007/0174277 A1
(43) Pub. Date: Jul. 26, 2007

(54) System and Method for Generating Automatic Blocking Filters for Record Linkage

(75) Inventors: Phan Hong Giang, Downingtown, PA (US); William A. Landi, Devon, PA (US); R. Bharat Rao, Berwyn, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 11/619,673

(22) Filed: Jan. 4, 2007

Related U.S. Application Data
(60) Provisional application No. 60/757,248, filed on Jan. 9, 2006.

(51) Int. Cl. G06F 7/00

(52) U.S. Cl. 707/7

(57) ABSTRACT

A method for generating blocking filters for record linkage includes providing a training database and an initial filter comprising a set of blocking keys, generating a set of positive training examples from said training database using said initial blocking keys and a given scoring method, generating from said positive training examples one or more acceptable blocking filters with a high recall with respect to said training examples, estimating a reduction rate of each of said acceptable filters, and selecting those acceptable filters with the reduction rates that exceed a predetermined threshold.

### CROSS REFERENCE TO RELATED UNITED STATES APPLICATIONS

This application claims priority from “Automatic Blocking Filter Generation for Record Linkage”, U.S. Provisional Application No. 60/757,248 of Giang, et al., filed Jan. 9, 2006, the contents of which are incorporated herein by reference.

### TECHNICAL FIELD

This invention is directed to the generation of efficient blocking filters for record linkage in databases.

### DISCUSSION OF THE RELATED ART

Record linkage is the problem of identifying database records that belong to or are representations of the same entities. For example, in a patient demographic database, the records represent patients. In this context, a record linkage task is linking records belonging to the same patients. This is important for statistical and clinical reasons. The presence of duplication would make statistical measures misleading. At the patient level, a clinical decision is typically made by a physician on the basis of the totality of information. Scattering vital patient data in different records, without linking them together, would make a complete picture impossible and would therefore inhibit correct decisions.

A naïve approach to record linkage would be to check any record against all other records in a database. But that would be too costly for a large database. For example, for 1 million records there are 500 billion possible pairs. If duplicate detection could be performed at a rate of 100,000 per second, then it would take 57.87 days of computer time to complete the task.

A two-stage process, illustrated in FIG. 1, can be used to overcome this problem. Given a set of possible record pairs 11, in the first stage, a blocking (also called filtering) technique 12 is used to reduce the number of record pairs. The goal of this stage is to exclude, using an inexpensive measure, those pairs that are unlikely to be duplicates of each other. In the second phase, the filtered pairs 13 are scored using a more expensive and reliable algorithm 14. The scoring algorithm outputs those pairs 15 that have scores exceeding a pre-selected threshold, which are considered duplicate pairs. Thus, the efficiency of blocking filter is important for a timely completion of record linkage task.

A standard approach to filtering is to calculate a set of key values for each record. The set of all records is then distributed into blocks by key values. The pairs that can be formed within each block will be scored. That is why filtering is known as blocking. Note that normally a record is involved in more than one block. For example, suppose record R1 has keys {a, b, c}, record R2 has keys {b, d, f} and record R3 has keys {k, h, a}. Then, the block identified by key a has two records R1 and R3, the block of key value b has two records R1 and R2, etc.

A blocking key scheme (or just blocking key for short) describes how key values for a record are calculated. A simple blocking key is specified by a sequence of character positions. For example a blocking key could be formed by taking the first four characters of a family name field. In general, each character position is actually a pair of two parameters (f, i) where f denotes the data field and i denote the index from which a character will be extracted. An index i can be counted from either the left margin or the right margin of a string. A positive value of an index indicates that it is counted from the left margin, while a negative value indicates that it is counted from the right margin. For example, for first name string “John” the character at position (First_Name, −2) is ‘h’, and the character at position (First_Name, 2) is ‘o’.

A filter is a set of one or more blocking keys. The use of more than one blocking keys means that if a duplicate pair fails one key then it may still be caught by the other key. Thus, minor errors occurred in keys can be tolerated. Finding a good blocking filter (or key set) is challenging because the number of possible blocking keys is astronomical. For example, if there are 100 positions to choose from, the number of keys of length 5 is 75,287,520.

A blocking key is evaluated based on two criteria: recall and precision. Recall is the ratio of the number of duplicate pairs which pass through the filter over the total number of duplicate pairs. Precision is the ratio of the number of duplicate pairs which pass through the filter over the number of filtered pairs. In other words, the higher the recall the fewer the number of actual duplicates will be mistakenly excluded by the filter, and the higher the precision the lower number of junk pairs go through the filter. These two criteria complement each other. On one hand, a trivial filter that excludes nothing has an absolute recall of 100%. But this trivial filter would let many junk pairs pass through and therefore has extremely low precision. On the other hand, high precision can be achieved by requiring an exact match on every data field. However, this filter would exclude many true duplicate pairs that have minor differences.

The current practice is to choose blocking filters by educated guessing. That is, human experts manually pick blocking filters based on experience. This process is unreliable and does not guarantee optimal filters because of the enormous number of possible candidates.

### SUMMARY OF THE INVENTION

Exemplary embodiments of the invention as described herein generally include methods and systems for using machine learning techniques to train filters. Method steps include (1) sampling the space of possible record pairs; (2) making character-by-character comparison for each sampled record pair to obtain a binary comparison vector; (3) scoring each sampled pair to get labels for comparison vectors; and (4) using machine learning techniques, such as decision trees or Boolean minimization, to train blocking keys from the data set. A method according to an embodiment of the invention leverages the given scoring algorithm to generate training data for learning filter. One starts with a “safe” filter that has high recall but not necessarily high precision, then finds a filter that has as good recall as the safe filter but has as high precision as possible. An iterative process is used to improve existing blocking keys. A method according to an embodiment of the invention takes advantage of expert experience about good blocking keys, and by separating the optimization of recall and precision criteria, can handle large and extremely unbalanced data sets.

A method according to an embodiment of the invention that can leverage “scores” to generate data to learn an optimal “filter” is useful in any two-component process in which the first phase plays the role of a preliminary filter whose main goal is to reduce the processing load for the more expensive second component. Applications that need to process large amounts of data, such as biomedical applications, often have this structure.

According to an aspect of the invention, there is provided a method for generating blocking filters for record linkage, including providing a training database and an initial filter comprising a set of blocking keys, generating a set of positive training examples from said training database using said initial blocking keys and a given scoring method, generating from said positive training examples one or more acceptable blocking filters with a high recall with respect to said training examples, estimating a reduction rate of each of said acceptable filters, and selecting those acceptable filters with the reduction rates that exceed a predetermined threshold.

According to a further aspect of the invention, the method comprises, if the selected acceptable filters are unsatisfactory, selecting a new initial filter that is more tolerant from said selected filter set, and repeating said steps of generating positive training examples, generating one or more acceptable blocking filters, estimating a reduction rate of each filter, and selecting those acceptable filters with the highest reduction rates.

According to a further aspect of the invention, the initial filter has a high recall ratio and a low precision.

According to a further aspect of the invention, generating positive training examples comprises using said initial filter and said scoring method to detect duplicate record pairs in at least a subset of said database, and for each duplicate pair, generating a character comparison vector.

According to a further aspect of the invention, detecting duplicate pairs in said database comprises calculating n key values for each record in said subset of said database, scoring those records that share at least one key value, and retaining those pairs whose score exceed a pre-determined value.

According to a further aspect of the invention, each initial blocking key set includes a number of blocking key schemes formed by the key set and the number of character positions in each key.

According to a further aspect of the invention, each acceptable blocking filter has a confirmation probability on said positive training example set that exceeds a predetermined threshold, wherein said confirmation probability is the ratio of the number of examples in said positive training example set confirmed by said acceptable blocking filter over the total number of examples in said positive training example set.

According to a further aspect of the invention, estimating the reduction rate of each acceptable filter comprises repeating said steps of randomly selecting a pair of records from said training database, computing a character comparison vector for said randomly selected pair, and checking said character comparison vector with said acceptable filter, and incrementing a frequency if said character comparison vector is confirmed by said acceptable filter, until a sufficiently large sample of record pairs is obtained, wherein a reduction rate is (1-frequency/sample-size), wherein sample-size is the number of randomly selected record pairs in said sample.

According to a further aspect of the invention, making said new initial filter more tolerant comprises either dropping one or more characters from the key specification, or adding a new key to said initial filter.

According to an aspect of the invention, there is provided a method for generating blocking filters for record linkage, including providing a training database and an initial filter comprising a set of blocking keys, generating a set of positive training examples from said training database using said initial blocking keys and a given scoring method, generating from said positive training examples one or more acceptable blocking filters with a high recall with respect to said training examples, estimating a reduction rate of each of said acceptable filters, and selecting those acceptable filters with the reduction rates that exceed a predetermined threshold.

According to a further aspect of the invention, the method comprises, if the selected acceptable filters are unsatisfactory, selecting a new initial filter that is more tolerant from said selected filter set, and repeating said steps of generating positive training examples, generating one or more acceptable blocking filters, estimating a reduction rate of each filter, and selecting those acceptable filters with the highest reduction rates.

According to a further aspect of the invention, the initial filter has a high recall ratio and a low precision.

According to a further aspect of the invention, generating positive training examples comprises using said initial filter and said scoring method to detect duplicate record pairs in at least a subset of said database, and for each duplicate pair, generating a character comparison vector.

According to a further aspect of the invention, detecting duplicate pairs in said database comprises calculating n key values for each record in said subset of said database, scoring those records that share at least one key value, and retaining those pairs whose score exceed a pre-determined value.

According to a further aspect of the invention, each initial blocking key set includes a number of blocking key schemes formed by the key set and the number of character positions in each key.

According to a further aspect of the invention, each acceptable blocking filter has a confirmation probability on said positive training example set that exceeds a predetermined threshold, wherein said confirmation probability is the ratio of the number of examples in said positive training example set confirmed by said acceptable blocking filter over the total number of examples in said positive training example set.

According to a further aspect of the invention, estimating the reduction rate of each acceptable filter comprises repeating said steps of randomly selecting a pair of records from said training database, computing a character comparison vector for said randomly selected pair, and checking said character comparison vector with said acceptable filter, and incrementing a frequency if said character comparison vector is confirmed by said acceptable filter, until a sufficiently large sample of record pairs is obtained, wherein a reduction rate is (1-frequency/sample-size), wherein sample-size is the number of randomly selected record pairs in said sample.

According to a further aspect of the invention, making said new initial filter more tolerant comprises either dropping one or more characters from the key specification, or adding a new key to said initial filter.

According to another aspect of the invention, there is provided a method for generating blocking filters for record linkage including providing a set of duplicate record pairs, generating from said set of duplicate record pairs a set of blocking filters with a confirmation probability on said set of duplicate record pairs that exceeds a predetermined threshold, wherein said confirmation probability is the ratio of the number of examples in said set of duplicate record pairs confirmed by each said blocking filter over the total number of examples in said set of duplicate record pairs, computing character comparison vector for each record pair in a random set of record pairs, and checking each said character comparison vector with each said blocking filter, and retaining those blocking filters whose confirmation frequency percentage rate is below a predetermined threshold.

According to a further aspect of the invention, checking each said character comparison vector comprises incrementing a frequency counter of each blocking filter if said character comparison vector is confirmed by said blocking filter, wherein a frequency percentage rate is the frequency counter divided by the number of record pairs in said random set.

According to a further aspect of the invention, providing a set of duplicate record pairs comprises providing a training database of records, an initial filter comprising a set of blocking keys with a high recall ratio, and a scoring algorithm and using said initial filter with said scoring algorithm to detect duplicate record pairs in at least a subset of said database.

According to another aspect of the invention, there is provided a program storage device readable by a computer, tangibly embodying a program of instructions executable by the computer to perform the method steps for generating blocking filters for record linkage.

### BRIEF DESCRIPTION OF THE DRAWINGS

FIG. 1 is a flowchart of a two-stage process for detecting duplicate records.

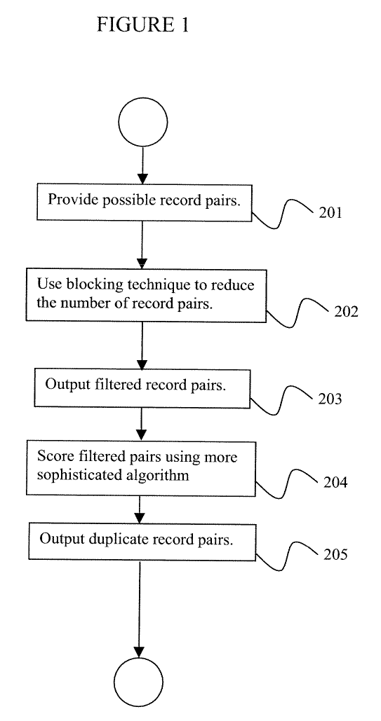

FIG. 2 is a flowchart of a filtering method according to an embodiment of the invention.

FIG. 3 is a block diagram of an exemplary computer system for implementing a method for automatically generating blocking filters, according to an embodiment of the invention.

### DETAILED DESCRIPTION OF THE PREFERRED EMBODIMENTS

Exemplary embodiments of the invention as described herein generally include systems and methods for generating efficient blocking filters for record linkage of large databases. Blocking filters are used to select the record pairs that will go through scoring process in order to discover duplication. A method according to an embodiment of the invention takes as input the set of duplicate pairs detected using an inefficient blocking filter and find the most efficient blocking filters without loss of sensitivity. Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

Database records can be thought as rows of a table. The table columns are record fields. As an example to clarify the terminology used herein below, consider the following.

| Record ID | LastName | FirstName | DOB |
|---|---|---|---|
| 1 | Smith | Jim | 12/4/1970 |
| 2 | Smith | John | 10/4/1970 |

A character position in a record field is specified by a pair (field, position-within-field). An example is the following set of 12 character positions. Note that a negative value for position indicates that it counts from the right margin.
(LastName, 1)
(LastName, 2)
(LastName, −2)
(LastName, −1)
(FirstName, 1)
(FirstName, 2)
(FirstName, −2)
(FirstName, −1)
(DOB, 1)
(DOB, 2)
(DOB, −2)
(DOB, −1)
   A record is viewed as a string of length 12:
SmthJiim1270
SmthJohn1070
   The character comparison vector V for two records is 111110001011

Consider two blocking key schemes, or blocking filters K:
BK1={ (LastName, 1), (LastName, −1 ), (DOB, 1), (DOB, 2 )}
BK2={ (LastName, 1), (LastName, 2), (LastName,−2), (FirstName, 1)}

The key values for the two records are given in the following table.

| | BK1 | BK2 |
|---|---|---|
| Record 1 | Sm12 | SmtJ |
| Record 2 | Sm10 | SmtJ |

Thus, a block identified with value Sm12 has only one record {1}, a block with key value Sm10 has one record {2}, and a block with key value SmtJ has both records {1,2}.

If records R1 and R2 share at least one key value produced by a blocking key set K, then one can say that K filters-in pair (R1, R2), or, alternatively, the pair (R1, R2) passes-through the filter. For example, BK2 filters-in pair {1, 2}.

The question of whether or not a record pair passes through a filter K can be answered by just looking at the comparison vector. The part of the comparison vector that corresponds to BK1 is 1110, and to BK2 is 1111. So, a key set K filters-in pair (R1, R2) iff max(min(BK1(V)), min(BK2(V))=1. Thus each blocking key set is identified with a disjunctive normal form (DNF), a standardization (or normalization) of a logical formula which is a disjunction of conjunctive clauses.

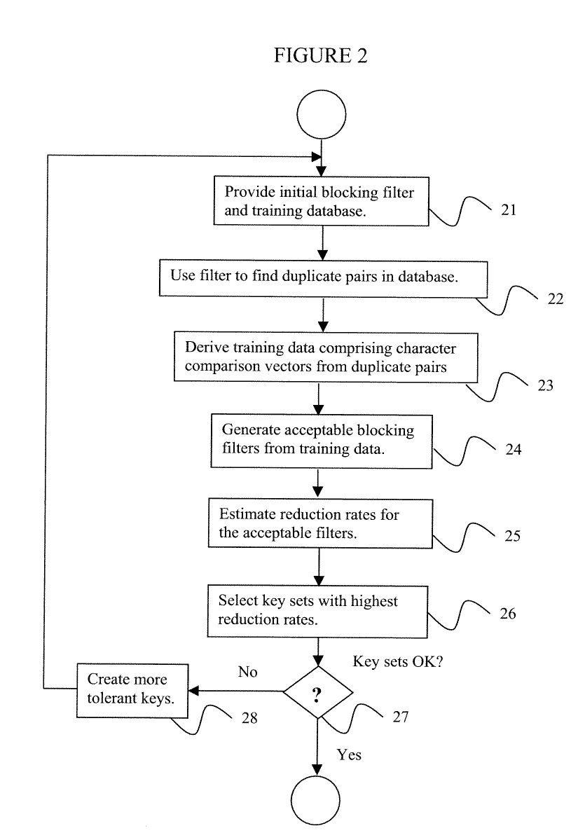

A flowchart of a method for automatically generating blocking filters according to an embodiment of the invention is presented in FIG. 2. With the above explanations, this method can be described in detail. Referring now to the figure, given a training database, a method starts at step 21 from an initial filter K that has a set of n blocking keys schemes. The main considerations at this stage are that this initial filter should have a high recall ratio and be able to obtain a full list of duplicates on a training database in an acceptable time. The reduction rate of the filter is unimportant at this point.

This filter can be used to generate positive examples for training in two steps. At step 22, the filter is used to find duplicate pairs on whole database or a subset of it. In general, duplicate pairs for training purposes can be derived from any source or technique, including pairs found manually. This training set could be whole database or a subset of records in the database. The more records that are considered, the more training data can be generated, but more records also mean that the process takes more time. For each record, n key values are calculated. The records that share at least one key value will be scored by the given scoring algorithm. Those pairs whose score exceeds a pre-set threshold will be declared duplicates. At step 23, training data comprising character comparison vectors are derived from these found duplicate pairs. For each of duplicate pair, a character comparison vector (V above) is generated. It results in a data set D.

The training data is used to generate many blocking filters at step 24 such that each generated filter has a high recall with respect to the generated data set. These filters are known as acceptable filters. Blocking key sets are generated for the data set D. Each blocking key set has two parameters: (1) the number of blocking key schemes; and (2) the numbers of character positions in each key. These parameter values can be either pre-set or automatically determined. The condition for generating blocking key sets (which are associated with a DNF) is that the confirmation probability on D is higher than a pre-set threshold called the acceptability level. The confirmation probability of a DNF on a set D is the ratio of the number of data points in D confirmed by the DNF over the total number of data points in D. This condition ensures that all filters have an acceptable recall rate. The set of generated blocking filters is denoted by K.

The efficiency (reduction rate) of the acceptable filters is estimated at step 25. This can be done by random sampling of the space of possible record pairs and calculating the probability that a filter prevents pairs from passing-through. This step is intended to optimize the precision rate. For a random sample S from the space of all possible record pairs, the confirmation probability of each key set K in K is calculated. The large size of the sample often requires a lot of memory. According to an embodiment of the invention, the following procedure, which does not have this limitation, can be used.

1. Pick randomly a pair of records. This can be done by generating two random numbers and using these numbers to identify the records.

2. Compute the character comparison vector V.

3. For each key set K, check if K confirms V. If so, the frequency counter for the key set K is incremented by 1.

4. Go to step 1 until the number of points considered is equal to the required sample size.

For each key set K the reduction rate is (1 - frequency/sample-size). In theory, this procedure according to an embodiment of the invention can handle a sample of any size because at any moment only one data point is stored in the memory.

At step 26, those filters with the highest reduction rates (or lowest frequency/sample-size percentage rates) are selected. Only key sets that have reduction rate higher than a pre-set threshold are retained for further consideration. Other key sets are deleted. According to another embodiment of the invention, this step can be embedded in step 25. The number of key sets under consideration is gradually reduced as the number of sample points increases.

The found filters are checked at step 27. If the filters are satisfactory, the generation process terminates. There are two criteria for a blocking filter to be “satisfactory”. First, there should be a high recall on the set of positive examples, i.e., the ratio of positive examples that get through the filter over the total number of positive examples, and second, there should be a high reduction rate (equivalently high precision) on the set of randomly created examples, regardless of whether positive or negative. This means in particular the ratio of examples from the set of randomly created examples blocked by the filter over the total number of examples. For this ratio, higher is better. It may appear that the two criteria seem to be contradictory. But in fact, the criteria are not contradictory because the recall rate applies to the set of positive training examples while the reduction rate applies to the randomly created examples.

If the filters are not satisfactory, more tolerant filters can be created at step 28 from the selected filters, and the process returns to step 21. More tolerant key sets are created on the basis of selected key set. Remember that in order for a key set to confirm a record pair, the key value sets produced (for each record) must have at least one common value. The latter means that the characters at the key's positions must be the same. One can make a filter more tolerant by (1) dropping some position(s) from its key specification or (2) adding a new key to the filter.

A method according to an embodiment of the invention can separately and iteratively optimize two conflicting criteria for good blocking keys, and this separation enables the handling of very large data sets and extremely unbalanced data sets. An implementation of a method according to an embodiment of the invention has been able to find extremely efficient blocking filters.

It is to be understood that various modifications to embodiments of the invention and the generic principles and features described herein will be readily apparent to those skilled in the art. Thus, embodiments of the invention are not intended to be limited to the embodiment shown but is to be accorded the widest scope consistent with the principles and features described herein.

Furthermore, it is to be understood that embodiments of the invention can be implemented in various forms of hardware, software, firmware, special purpose processes, or a combination thereof. In one embodiment, an embodiments of the invention can be implemented in software as an application program tangibly embodied on a computer readable program storage device. The application program can be uploaded to, and executed by, a machine comprising any suitable architecture.

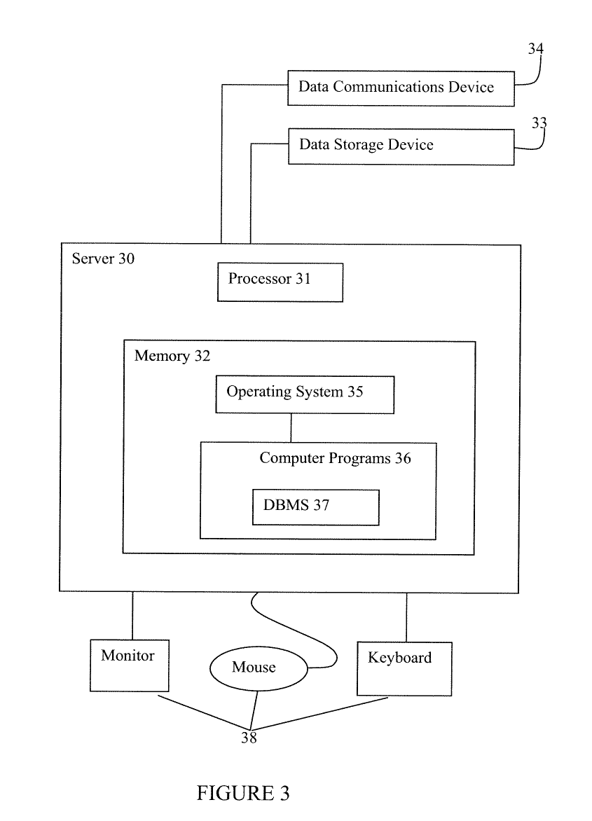

Accordingly, FIG. 3 illustrates a hardware environment used to implement an embodiment of the invention. As illustrated in FIG. 3, an embodiment of the present invention is implemented in a server computer (“server”) 30. The server 30 generally includes, a processor 31, a memory 32 such as a random access memory (RAM), a data storage device 33 (e.g., hard drive, floppy disk drive, CD-ROM disk drive, etc.), a data communication device 34 (e.g., modem, network interface device, etc.), and input/output devices 38 such as a monitor (e.g., CRT, LCD display, etc.), a pointing device (e.g., a mouse, a track ball, a pad or any other device responsive to touch, etc.) and a keyboard. It is envisioned that attached to the computer 30 may be other devices such as read only memory (ROM), a video card drive, printers, and other peripheral devices including local and wide area network interface devices, etc. One of ordinary skill in the art will recognize that any combination of the above system components may be used to configure the server 30.

The server 30 operates under the control of an operating system (“OS”) 35, such as Linux, WINDOWS™, WINDOWS NT™, etc., which typically, is loaded into the memory 32 during the server 30 start-up (boot-up) sequence after power-on or reset. In operation, the OS 35 controls the execution by the server 30 of computer programs 36, including server and/or client-server programs. Alternatively, a system and method in accordance with an embodiment of the invention may be implemented with any one or all of the computer programs 36 embedded in the OS 35 itself without departing from the scope of an embodiment of the invention. However, the client programs can be separate from the server programs and may not be resident on the server.

The OS 35 and the computer programs 36 each comprise computer readable instructions which, in general, are tangibly embodied in or are readable from a media such as the memory 32, the data storage device 33 and/or the data communications device 34. When executed by the server 30, the instructions cause the server 30 to perform the steps necessary to implement an embodiment of the invention. Thus, the present invention may be implemented as a method, apparatus, or an article of manufacture (a computer-readable media or device) using programming and/or engineering techniques to produce software, hardware, firmware, or any combination thereof.

The server 30 is typically used as a part of an information search and retrieval system capable of receiving, retrieving and/or dissemination information over the Internet, or any other network environment. One of ordinary skill in the art will recognize that this system may include more than one of server 30.

In the information search and retrieval system, such as a digital library system, a client program communicates with the server 30 by, inter alia, issuing to the server search requests and queries. The server 30 then responds by providing the requested information. The digital library system is typically implemented using a database management system software (DBMS) 37. The DBMS 37 receives and responds to search and retrieval requests and termed queries from the client. In one embodiment, the DBMS 37 is server-resident.

Objects are typically stored in a relational database connected to an object server, and the information about the objects is stored in a relational database connected to a library server, wherein the server program(s) operate in conjunction with the (DBMS) 37 to first store the objects and then to retrieve the objects. One of ordinary skill in the art will recognize that the foregoing is an exemplary configuration of a system which embodies the present invention, and that other system configurations such as an ultrasound machine coupled to a workstation via network to access the data in the ultrasound machine may be used without departing from the scope and spirit of an embodiment of the present invention.

While embodiments of the invention has been described in detail with reference to a preferred embodiment, those skilled in the art will appreciate that various modifications and substitutions can be made thereto without departing from the spirit and scope of the embodiments of the invention as set forth in the appended claims.

What is claimed is:

1. A method for generating blocking filters for record linkage comprising the steps of:
providing a training database and an initial filter comprising a set of blocking keys;
generating a set of positive training examples from said training database using said initial blocking keys and a given scoring method;
generating from said positive training examples one or more acceptable blocking filters with a high recall with respect to said training examples;
estimating a reduction rate of each of said acceptable filters; and
selecting those acceptable filters with the reduction rates that exceed a predetermined threshold.

2. The method of claim 1, further comprising, if the selected acceptable filters are unsatisfactory, selecting a new initial filter that is more tolerant from said selected filter set, and repeating said steps of generating positive training examples, generating one or more acceptable blocking filters, estimating a reduction rate of each filter, and selecting those acceptable filters with the highest reduction rates.

3. The method of claim 1, wherein said initial filter has a high recall ratio and a low precision.

4. The method of claim 1, wherein generating positive training examples comprises using said initial filter and said scoring method to detect duplicate record pairs in at least a subset of said database, and for each duplicate pair, generating a character comparison vector.

5. The method of claim 4, wherein detecting duplicate pairs in said database comprises calculating n key values for each record in said subset of said database, scoring those records that share at least one key value, and retaining those pairs whose score exceed a pre-determined value.

6. The method of claim 1, wherein each initial blocking key set includes a number of blocking key schemes formed by the key set and the number of character positions in each key.

7. The method of claim 1, wherein each acceptable blocking filter has a confirmation probability on said positive training example set that exceeds a predetermined threshold, wherein said confirmation probability is the ratio of the number of examples in said positive training example set confirmed by said acceptable blocking filter over the total number of examples in said positive training example set.

8. The method of claim 1, wherein estimating the reduction rate of each acceptable filter comprises repeating said steps of
randomly selecting a pair of records from said training database;
computing a character comparison vector for said randomly selected pair; and
checking said character comparison vector with said acceptable filter, and incrementing a frequency if said character comparison vector is confirmed by said acceptable filter,
until a sufficiently large sample of record pairs is obtained, wherein a reduction rate is (1-frequency/sample-size), wherein sample-size is the number of randomly selected record pairs in said sample.

9. The method of claim 2, wherein making said new initial filter more tolerant comprises either dropping one or more characters from the key specification, or adding a new key to said initial filter.

10. A method for generating blocking filters for record linkage comprising the steps of:
providing a set of duplicate record pairs;
generating from said set of duplicate record pairs a set of blocking filters with a confirmation probability on said set of duplicate record pairs that exceeds a predetermined threshold, wherein said confirmation probability is the ratio of the number of examples in said set of duplicate record pairs confirmed by each said blocking filter over the total number of examples in said set of duplicate record pairs; computing character comparison vector for each record pair in a random set of record pairs; and
checking each said character comparison vector with each said blocking filter, and retaining those blocking filters whose confirmation frequency percentage rate is below a predetermined threshold.

11. The method of claim 10, wherein checking each said character comparison vector comprises incrementing a frequency counter of each blocking filter if said character comparison vector is confirmed by said blocking filter, wherein a frequency percentage rate is the frequency counter divided by the number of record pairs in said random set.

12. The method of claim 10, wherein providing a set of duplicate record pairs comprises providing a training database of records, an initial filter comprising a set of blocking keys with a high recall ratio, and a scoring algorithm and using said initial filter with said scoring algorithm to detect duplicate record pairs in at least a subset of said database.

13. A program storage device readable by a computer, tangibly embodying a program of instructions executable by the computer to perform the method steps for generating blocking filters for record linkage, said method comprising the steps of:
providing a training database and an initial filter comprising a set of blocking keys;
generating a set of positive training examples from said training database using said initial blocking keys and a given scoring method;
generating from said positive training examples one or more acceptable blocking filters with a high recall with respect to said training examples;
estimating a reduction rate of each of said acceptable filters; and
selecting those acceptable filters with the reduction rates that exceed a predetermined threshold.

14. The computer readable program storage device of claim 13, the method further comprising, if the selected acceptable filters are unsatisfactory, selecting a new initial filter that is more tolerant from said selected filter set, and repeating said steps of generating positive training examples, generating one or more acceptable blocking filters, estimating a reduction rate of each filter, and selecting those acceptable filters with the highest reduction rates.

15. The computer readable program storage device of claim 13, wherein said initial filter has a high recall ratio and a low precision.

16. The computer readable program storage device of claim 13, wherein generating positive training examples comprises using said initial filter and said scoring method to detect duplicate record pairs in at least a subset of said database, and for each duplicate pair, generating a character comparison vector.

17. The computer readable program storage device of claim 16, wherein detecting duplicate pairs in said database comprises calculating n key values for each record in said subset of said database, scoring those records that share at least one key value, and retaining those pairs whose score exceed a pre-determined value.

18. The computer readable program storage device of claim 13, wherein each initial blocking key set includes a number of blocking key schemes formed by the key set and the number of character positions in each key.

19. The computer readable program storage device of claim 13, wherein each acceptable blocking filter has a confirmation probability on said positive training example set that exceeds a predetermined threshold, wherein said confirmation probability is the ratio of the number of examples in said positive training example set confirmed by said acceptable blocking filter over the total number of examples in said positive training example set.

20. The computer readable program storage device of claim 13, wherein estimating the reduction rate of each acceptable filter comprises repeating said steps of
randomly selecting a pair of records from said training database;
computing a character comparison vector for said randomly selected pair; and
checking said character comparison vector with said acceptable filter, and incrementing a frequency if said character comparison vector is confirmed by said acceptable filter,
until a sufficiently large sample of record pairs is obtained, wherein a reduction rate is (1-frequency/sample-size), wherein sample-size is the number of randomly selected record pairs in said sample.

21. The computer readable program storage device of claim 14, wherein making said new initial filter more tolerant comprises either dropping one or more characters from the key specification, or adding a new key to said initial filter.
